(19) United States
(12) Patent Application Publication
(10) Pub. No.: US 2015/0241835 A1
(43) Pub. Date: Aug. 27, 2015

(54) IMAGE FORMATION APPARATUS

(71) Applicant: Oki Data Corporation, Tokyo (JP)

(72) Inventor: Yukio ITO, Tokyo (JP)

(21) Appl. No.: 14/627,898

(22) Filed: Feb. 20, 2015

(30) Foreign Application Priority Data
Feb. 24, 2014 (JP) 2014-032741

(51) Int. Cl. G03G 15/00

(52) U.S. Cl. CPC G03G 15/80

(57) ABSTRACT

An image formation apparatus includes: an interface unit that receives data; an image formation unit that forms an image on a medium based on the received data; a main controller that controls the interface unit and the image formation unit; a power supply unit that supplies power from an external power source into the image formation apparatus; and a power source management unit that controls the power supply unit. When the power supply from the external power source is stopped in a power save mode and then is resumed, the power supply unit supplies no power to the interface unit and the main controller but supplies power to the power source management unit. When the power supply from the external power source is stopped in a normal operational mode and then is resumed, the power supply unit supplies power to the power source management unit, the interface unit, and the main controller.

### CROSS REFERENCE TO RELATED APPLICATIONS

This application claims priority based on 35 USC 119 from prior Japanese Patent Application No. JP 2014-032741 filed on Feb. 24, 2013, entitled “IMAGE FORMATION APPARATUS”, the entire contents of which are incorporated herein by reference.

### BACKGROUND OF THE INVENTION

1. Field of the Invention

This disclosure relates to an image formation apparatus.

2. Description of the Related Art

For example, like the image processing apparatus described in Japanese Unexamined Patent Application Publication No. 2009-178855, a technique is conventionally known in which when no operation is performed on an image processing apparatus for a certain time period, an operational mode is switched to a power-saving mode with less power consumption.

### SUMMARY OF THE INVENTION

However, the conventional technique is unable to control the operational mode in a case where use conditions cannot be monitored, such as the case where an external power source (AC power source) is shut off due to a failure such as a power failure. Thus, in the conventional technique, after the power supply from the external power source is resumed, the relevant apparatus starts up in the normal mode regardless of the operational mode before the shut-off, and in the normal mode, power consumption is greater than that in the power-saving mode. Therefore, in the conventional technique, when a subsequent operation is not performed after the start-up in normal mode, power is wastefully consumed.

Thus, an embodiment of the invention provides an image formation apparatus that avoids wasteful power consumption even when an external power source is recovered from a failure such as a power failure.

### Solution to Problem

An aspect of the invention provides an image formation apparatus that operates in a first operational mode and a second operational mode which consumes less power than the first operational mode. The image formation apparatus includes: an interface unit configured to receive image formation data; an image formation unit configured to form an image based on the image formation data received by the interface unit; a main controller configured to control the interface unit and the image formation unit; a power supply unit configured to supply power from an external power source into the image formation apparatus; and a power source management unit configured to control the power supply unit.

When the power supply from the external power source is stopped in the second operational mode and then the power supply from the external power source is resumed, the power supply unit supplies no power to the interface unit and the main controller, but supplies power to the power source management unit. When the power supply from the external power source is stopped in the first operational mode and then the power supply from the external power source is resumed, the power supply unit supplies power to the power source management unit, the interface unit, and the main controller.

Another aspect of the invention provides an image formation apparatus that operates in a first operational mode and a second operational mode which consumes less power than the first operational mode. The image formation apparatus includes: an interface unit configured to receive image formation data; an image formation unit configured to form an image based on the image formation data received by the interface unit; a main controller configured to control the interface unit and the image formation unit; a power supply unit configured to supply power from an external power source into the image formation apparatus; and a power source management unit configured to control the power supply unit and receive an input of an operation. In a state where the image formation apparatus is switched to the second operational mode due to the input of an operation received by the power source management unit, when the power supply from the external power source is stopped and then the power supply from the external power source is resumed, the power supply unit supplies no power to the interface unit and the main controller, but supplies power to the power source management unit. In a state where the image formation apparatus is switched to the second operational mode due to non-operation of the image formation apparatus for a predetermined time, when power supply from the external power source is stopped and then power supply from the external power source is resumed, the power supply unit supplies power to the power source management unit, the interface unit, and the main controller. When the power supply from the external power source is stopped in the first operational mode and then the power supply from the external power source is resumed, the power supply unit supplies power to the power source management unit, the interface unit, and the main controller.

According to these aspects, even when an external power source is recovered from a failure such as a power failure, it is possible to avoid wasteful power consumption.

### BRIEF DESCRIPTION OF THE DRAWINGS

FIG. 1 is a block diagram schematically illustrating the configuration of an image formation apparatus;

FIG. 2 is a table illustrating operational modes in an image formation apparatus and the non-energized state in which power is not supplied from an AC power source due to a failure such as a power failure;

FIG. 3 is a schematic diagram illustrating a flow chart at the time of the switch to a sleep mode;

FIG. 4 is a schematic diagram illustrating a flow chart at the time of the switch to the off mode;

FIG. 5 is a schematic diagram illustrating a flow chart (part 1) at the time of an input from an AC power source; and

FIG. 6 is a schematic diagram illustrating a flow chart (part 2) at the time of an input from an AC power source.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### (Description of Configuration)

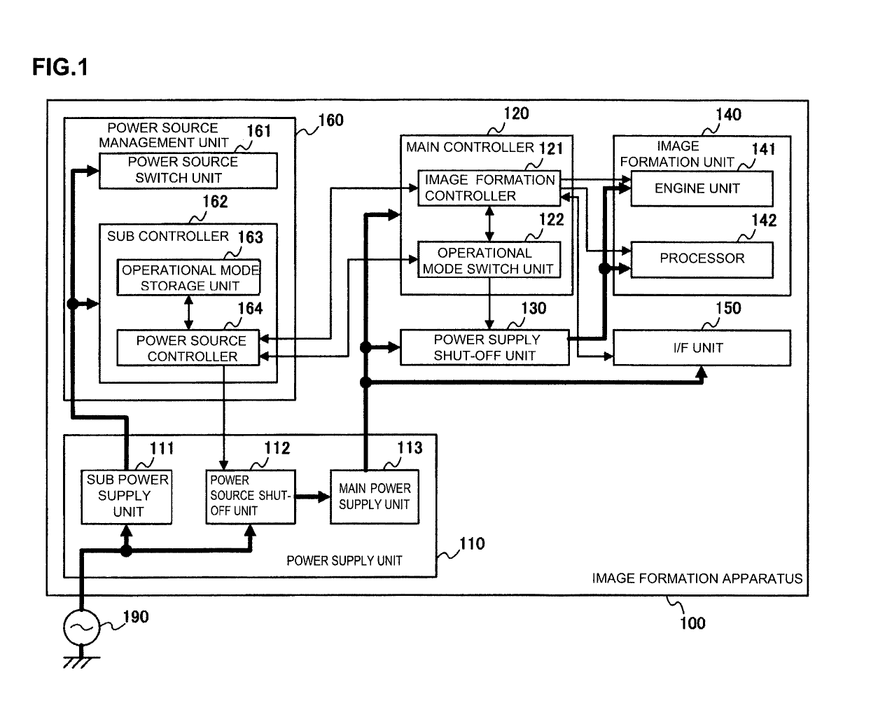

FIG. 1 is a block diagram schematically illustrating the configuration of image formation apparatus 100 according to an embodiment. Image formation apparatus 100 includes power supply unit 110, main controller 120, power supply shut-off unit 130, image formation unit 140, interface unit (hereinafter referred to as I/F unit) 150, and power source management unit 160.

Power supply unit 110 receives power supply from AC power source 190, which is an external power source, and supplies power into image formation apparatus 100. Here, power supply unit 110 switches from one unit to another to which power is supplied, according to a command from power source management unit 160. Power supply unit 110 includes sub power supply unit 111, power source shut-off unit 112, and main power supply unit 113. Sub power supply unit 111 receives power supply from AC power source 190, and supplies power to power source management unit 160. Because sub power supply unit 111 does not supply power to image formation unit 140 and main controller 120, both having a high power consumption, it is sufficient that sub power supply unit 111 have a low capacity and more emphasis on power source efficiency under a low load.

Power supply shut-off unit 112 shuts off the power supply from AC power source 190 to main power supply unit 113 according to a command from power source management unit 160. In other words, when power source shut-off unit 112 shuts off the power supply from AC power source 190 to main power supply unit 113 (OFF state), power is not supplied from AC power source 190 to main power supply unit 113. Conversely, when power source shut-off unit 112 does not shut off the power supply from AC power source 190 to main power supply unit 113 (ON state), power is supplied from AC power source 190 to main power supply unit 113. For example, power source shut-off unit 112 includes a relay, and when a signal from power source management unit 160 is H, power source shut-off unit 112 allows power from AC power source 190 to be supplied to main power supply unit 113. However, when the signal is L, power source shut-off unit 112 shuts off the power supply from AC power source 190 to main power supply unit 113. Main power supply unit 113 receives a power supply from AC power source 190, and supplies power to main controller 120 and I/F unit 150, or main controller 120, image formation unit 140, and I/F unit 150 according to an operational mode. Because main power supply unit 113 supplies power to image formation unit 140 and main controller 120, both having high power consumption, main power supply unit 113 has a high capacity and more emphasis on power source efficiency under a high load. In other words, the power supplied by main power supply unit 113 is higher than the power supplied by sub power supply unit 111.

Main controller 120 controls power supply shut-off unit 130, image formation unit 140, and I/F unit 150, and performs processing in image formation apparatus 100. For example, main controller 120 controls start-up (initialization) and stop processing of image formation apparatus 100, image formation processing in image formation apparatus 100, and switching processing between operational modes of image formation apparatus 100. Main controller 120 includes image formation controller 121 and operational mode switch unit 122. Image formation controller 121 controls image formation unit 140 and I/F unit 150. For example, when power is supplied to image formation unit 140, image formation controller 121 initializes image formation unit 140, and when the power supply to image formation 140 is stopped, image formation controller 121 deactivates image formation unit 140. In addition, image formation controller 121 controls image formation unit 140 to form (print) an image on a medium such as paper. Furthermore, image formation controller 121 controls I/F unit 150 to obtain image formation data.

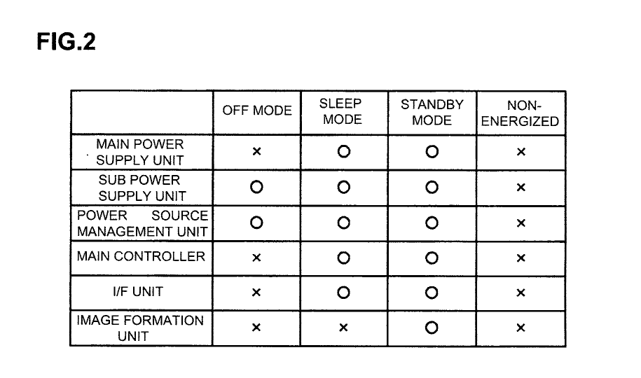

Operational mode switch unit 122 switches between operational modes in which image formation apparatus 100 operates. In this embodiment, the operational modes are an off mode, a sleep mode, and a standby mode. FIG. 2 is a table illustrating the three operational modes in image formation apparatus 100 and a non-energized state in which power is not supplied from AC power source 190 due to a failure such as a power failure. As illustrated in FIG. 2, when the operational mode is the off mode, power is supplied to sub power supply unit 111 and power source management unit 160, but power is not supplied to main power supply unit 113, main controller 120, I/F unit 150, and image formation unit 140. Because power is supplied to power source management unit 160 in the off mode, management of power source is made by power source management unit 160. In other words, power supply unit 110 is controlled by power source management unit 160. When the operational mode is the sleep mode, power is supplied to main power supply unit 113, sub power supply unit 111, power source management unit 160, main controller 120, and I/F unit 150, but power is not supplied to image formation unit 140. Since power is supplied to I/F unit 150 in the sleep mode, I/F unit 150 is capable of receiving image formation data from a host PC which is not illustrated. When the operational mode is the standby mode, power is supplied to main power supply unit 113, sub power supply unit 111, power source management unit 160, main controller 120, I/F unit 150, and image formation unit 140. Since power is supplied to image formation unit 140 in the standby mode, sensor monitoring and pre-heat operation are performed. In the non-energized state, power is not supplied to main power supply unit 113, sub power supply unit 111, power source management unit 160, main controller 120, I/F part 150, and image formation unit 140.

Here, according to the ON or OFF state of the power source of image formation apparatus 100, the operational modes of image formation apparatus 100 are divided into a first operational mode as the off mode and a second operational mode as on mode (the sleep mode and the standby mode). In this embodiment, when the power supply from AC power source 190 is stopped and then the power supply is resumed in the second operational mode, power supply unit 110 returns to the second operational mode in which power is not supplied to I/F unit 150 and main controller 120 but is supplied to power source management unit 160. When the power supply from AC power source 190 is stopped and then the power supply is resumed in the first operational mode, power supply unit 110 returns to the first operational mode in which power is supplied to power source management unit 160, main controller 120, and I/F unit 150.

Returning to the description of FIG. 1, operational mode switch unit 122 issues a command to power supply shut-off unit 130 according to the above-mentioned operational mode, thereby controlling (turning ON or OFF) the power supply from power supply unit 110 to image formation unit 140.

Specifically, when the operational mode is the sleep mode, operational mode switch unit 122 commands power supply shut-off unit 130 to shut off the power supply to image formation unit 140. On the other hand, when the operational mode is the standby mode, operational mode switch unit 122 commands power supply shut-off unit 130 not to shut off the power supply to image formation unit 140. Power supply shut-off unit 130 shuts off the power supply from main power supply unit 113 to image formation unit 140 according to a command from operational mode switch unit 122. In other words, when power supply shut-off unit 130 shuts off the power supply from main power supply unit 113 to image formation unit 140 (OFF state), power is not supplied from main power supply unit 113 to image formation unit 140. On the other hand, when power supply shut-off unit 130 does not shut off the power supply from main power supply unit 113 to image formation unit 140 (ON state), power is supplied from main power supply unit 113 to image formation unit 140. For example, power supply shut-off unit 130 also includes a relay, and when a signal from operational mode switch unit 122 is H, power supply shut-off unit 130 allows power from main power supply unit 113 to be supplied to image formation unit 140. However, when the signal is L, power supply shut-off unit 130 shuts off the power supply from main power supply unit 113 to image formation unit 140.

Image formation unit 140 forms an image on a medium such as paper. For example, image formation unit 140 forms an image based on the image formation data received by I/F unit 150. Image formation unit 140 includes engine unit 141 and processor 142. Engine unit 141 includes actuators such as a motor, a clutch, and a FAN, and performs operations including the transportation of media and a cooling of the apparatus. Processor 142 includes a development unit and a fuser unit, and performs operations including the forming and fusing of an image on a medium. I/F unit 150 transmits and receives data. For example, I/F unit 150 receives image formation data (print data) from a host PC which is not illustrated.

Power source management unit 160 controls power supply unit 110. Power source management unit 160 includes power source switch unit 161 and sub controller 162. Power source switch unit 161 receives the input of an operation. For example, power source switch unit 161 receives the input of an operation from a user, the operation commanding turning on or off the power source. Sub controller 162 monitors power source switch unit 161 and controls power supply unit 110. For example, sub controller 162 controls the turning on and off of the power supply from main power supply unit 113. Sub controller 162 operates with a power supply received from sub power supply unit 111. Sub controller 162 includes operational mode storage unit 163 and power source controller 164.

Operational mode storage unit 163 stores operational mode information indicating an operational mode of image formation apparatus 100. As described above, the operational modes of image formation apparatus 100 are the off mode, the sleep mode, and the standby mode, and the operational mode indicated by the operational mode information is the current operational mode of image formation apparatus 100. It is to be noted that operational mode storage unit 163 is achieved by a non-volatile memory. Power source controller 164 updates the operational mode information stored in operational mode storage unit 163, and controls (turn on or off) the power supply from main power supply unit 113 according to an operational mode indicated by the operational mode information stored in operational mode storage unit 163. For example, when the operational mode information stored in operational mode storage unit 163 indicates the off mode, power source controller 164 turns off the power supply from main power supply unit 113. On the other hand, when the operational mode information stored in operational mode storage unit 163 indicates the sleep mode or the standby mode, power source controller 164 sets the power supply from main power supply unit 113 to be ON. Here, when the power supply from main power supply unit 113 is to be turned on, sub controller 162 assigns H to the output signal to power source shut-off unit 112. When power supply from main power supply unit 113 is to be turned off, sub controller 162 assigns L to the output signal to power source shut-off unit 112.

### DESCRIPTION OF OPERATION

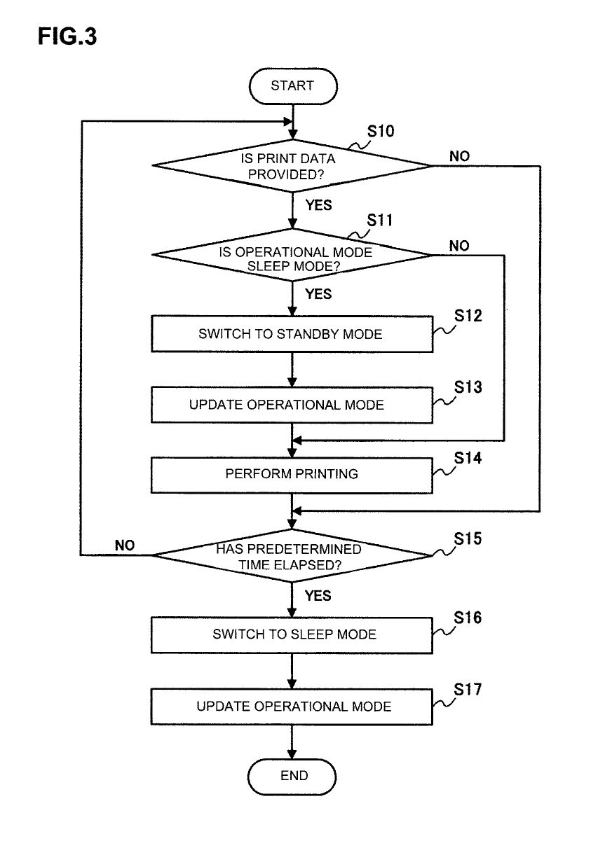

FIG. 3 is a schematic diagram illustrating a flow chart at the time of a switch to the sleep mode. It is assumed in the flow chart of FIG. 3 that the operational mode of image formation apparatus 100 is the sleep mode or the standby mode at the time of start. Image formation controller 121 determines whether or not I/F unit 150 has received image formation data from the host PC (S10). When image formation data has been received (Yes in S10), the processing proceeds to step S11, and when image formation data has not been received (No in S10), the processing proceeds to step S15.

In step S11, operational mode switch unit 122 determines whether or not the operational mode of image formation apparatus 100 is the sleep mode. For example, operational mode switch unit 122 inquires at power source controller 164 for the operational mode. In response to such an inquiry, power source controller 164 replies by providing the operational mode indicated by the operational mode information stored in operational mode storage unit 163. Operational mode switch unit 122 then recognizes the operational mode of image formation apparatus 100 from the reply by power source controller 164. When the operational mode is the sleep mode (Yes in S11), the processing proceeds to step S12, and when the operational mode is not the sleep mode (No in S11), the processing proceeds to step S14.

In step S12, operational mode switch unit 122 switches the operational mode from the sleep mode to the standby mode in order to process the image formation data received by I/F unit 150. For example, operational mode switch unit 122 commands power supply shut-off unit 130 to supply power to engine unit 141 and processor 142 of image formation unit 140. Operational mode switch unit 122 then commands image formation controller 121 to perform initial processing for image formation unit 140. Upon receiving such a command, image formation controller 121 performs an initial processing (such as a pre-heat operation) for image formation unit 140 after the start of a power supply to image formation unit 140. Operational mode switch unit 122 also commands power source controller 164 to update the operational mode from the sleep mode to the standby mode (S13). Upon receiving such a command, power source controller 164 updates the operational mode information stored in operational mode storage unit 163.

Image formation controller 121 causes image formation unit 140 to perform an image formation based on the image formation data received by I/F unit 150 (S14). Image formation controller 121 then determines whether or not a predetermined time has elapsed without receiving image formation data after a completion of the image formation in step S14 (S15). When the predetermined time has elapsed (Yes in S15), the processing proceeds to step S16.

In step S16, operational mode switch unit 122 switches the operational mode from the standby mode to the sleep mode in order to reduce the power consumption of image formation apparatus 100. For example, operational mode switch unit 122 commands image formation controller 121 to deactivate the processing of image formation unit 140. Upon receiving such a command, image formation controller 121 deactivates image formation unit 140 so that the power supply to image formation unit 140 may be turned off. After the deactivation of image formation unit 140 is completed, operational mode switch unit 122 commands power supply shut-off unit 130 to shut off the power supply to engine unit 141 and processor 142 of image formation unit 140. Operational mode switch unit 122 also commands power source controller 164 to update the operational mode from the standby mode to the sleep mode (S17). Upon receiving such a command, power source controller 164 updates the operational mode information stored in operational mode storage unit 163.

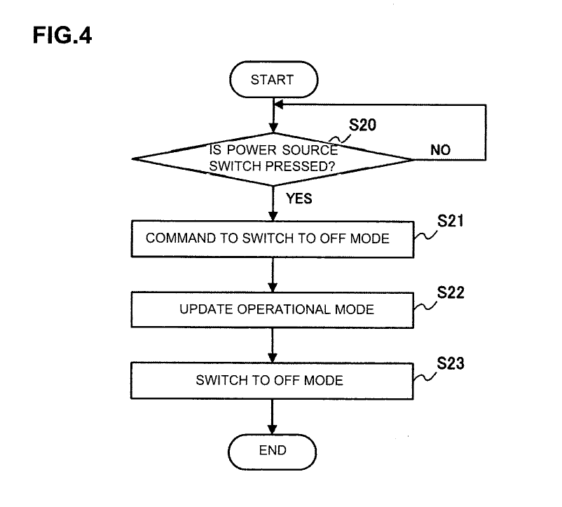

FIG. 4 is a schematic diagram illustrating a flow chart at the time of a switch to the off mode. It is assumed in the flow chart of FIG. 4 that the operational mode of image formation apparatus 100 is the sleep mode or the standby mode at the time of start. Power source controller 164 determines whether or not power source switch unit 161 has been pressed

(S20) . When power source switch unit 161 has been pressed

(Yes in S20), the processing proceeds to step S21. In step

S21, power source controller 164 commands image formation controller 121 to switch to the off mode. Upon receiving such a command, image formation controller 121 deactivates image formation unit 140 and I/F unit 150 when image formation unit 140 and I/F unit 150 have started up so that the power supply to image formation unit 140 and I/F unit 150 may be turned off. Image formation controller 121, when completing a preparation for switching to the off mode, notifies power source controller 164 of the completion of the preparation. Upon receiving such a notification, power source controller 164 updates the operational mode from the standby mode or the sleep mode to the off mode. The operational mode is indicated by the operational mode information stored in operational mode storage unit 163 (S22). Upon completion of the updating of the operational mode, power source controller 164 switches the operational mode of image formation apparatus 100 to the off mode. For example, power source controller 164 commands power source shut-off unit 112 to stop the power supply, and according to the command, power source shut-off unit 112 shuts off the power supply from AC power source 190 (S23). Consequently, the power supply to main power supply unit 113 from AC power source 190 is shut off, and main power supply unit 113 stops the power supply to main controller 120, image formation unit 140, and I/F unit 150.

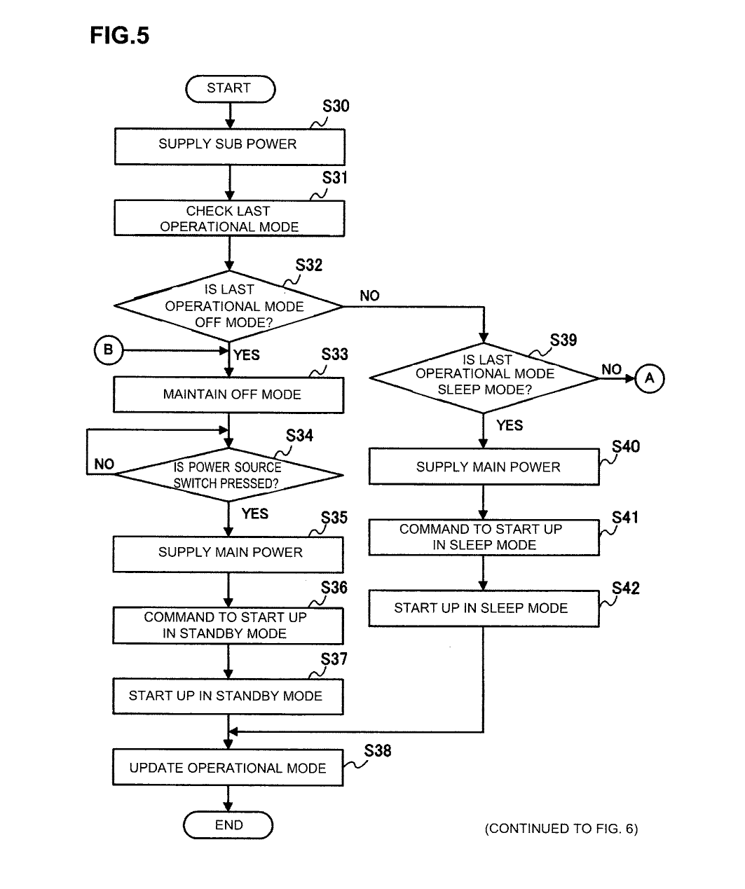

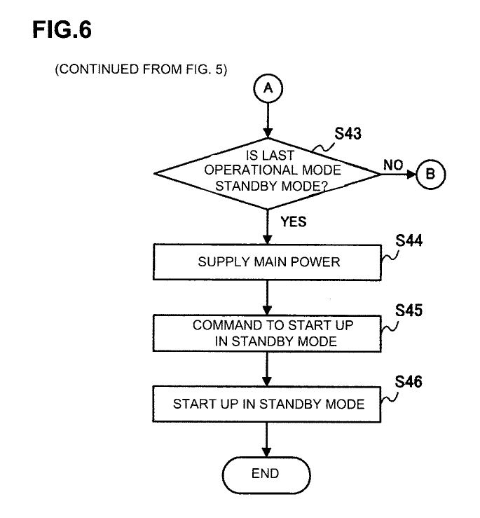

FIGS. 5 and 6 are each a schematic diagram illustrating a flow chart at the time of an input from AC power source 190. The flow chart of FIG. 5 starts when an input of AC power source 190, which has been stopped due to a failure such as a power failure, is resumed. When the power is supplied from AC power source 190, sub power supply unit 111 supplies power to power source management unit 160 (S30). At this point, power source shut-off unit 112 has not received a command from power source controller 164, and thus power source shut-off unit 112 shuts off the power supply from AC power source 190 to main power supply unit 113.

When power is supplied, power source controller 164 starts up in the off mode, and after completion of the start-up, power source controller 164 checks the operational mode indicated by the operational mode information stored in operational mode storage unit 163 (S31). Here, the operational mode indicated by the operational mode information stored in operational mode storage unit 163 is the last operational mode before the power supply from AC power source 190 is stopped. Power source controller 164 then determines whether or not the last operational mode is the off mode (S32). When the last operational mode is the off mode (Yes in S32), the processing proceeds to step S33, and when the last operational mode is not the off mode (No in S32), the processing proceeds to step S39.

In step S33, since the last operational mode before the power supply from AC power source 190 is stopped is the off mode, power source controller 164 maintains the operation in the off mode. In the off mode, power source controller 164 monitors power source switch unit 161 (S34). When power source controller 164 detects a pressing of power source switch unit 161 (Yes in S34), the processing proceeds to step S35. The operational mode is switched from the off mode to the standby mode by steps S35 to S37.

In step S35, power source controller 164 starts supplying power from main power supply unit 113. For example, power source controller 164 commands power source shut-off unit 112 to supply power, and according to such a command, power source shut-off unit 112 sets the power supply from AC power source 190 to be in the ON state. Consequently, power is supplied from AC power source 190 to main power supply unit 113, and main power supply unit 113 supplies power to main controller 120 and I/F unit 150.

Next, power source controller 164 commands operational mode switch unit 122 to start up in the standby mode (S36). Upon receiving such a command, operational mode switch unit 122 starts up in the standby mode (S37). For example, operational mode switch unit 122 commands power supply shut-off unit 130 to supply power to engine unit 141 and processor 142 of image formation unit 140. Operational mode switch unit 122 then commands image formation controller 121 to perform initial processing for image formation unit 140. Upon receiving such a command, image formation controller 121 performs initial processing for image formation unit 140 after the start of the power supply to image formation unit 140. Operational mode switch unit 122 then commands power source controller 164 to update the operational mode from the off mode to the standby mode (S38). Upon receiving such a command, power source controller 164 updates the operational mode information stored in operational mode storage unit 163.

In step S32, when the last operational mode is not the off mode (No in S32), the processing proceeds to step S39, and power source controller 164 determines whether or not the last operational mode is the sleep mode. When the last operational mode is the sleep mode (Yes in S39), the processing proceeds to step S40, and when the last operational mode is not the sleep mode (No in S39), the processing proceeds to step S43 of FIG. 6.

In step S40, power source controller 164 starts supplying power from main power supply unit 113. For example, power source controller 164 commands power source shut-off unit 112 to supply power, and according to such a command, power source shut-off unit 112 sets the power supply from AC power source 190 to be ON. Consequently, power is supplied from AC power source 190 to main power supply unit 113, and main power supply unit 113 supplies power to main controller 120 and I/F unit 150.

Next, power source controller 164 commands operational mode switch unit 122 to start up in the sleep mode (S41). Upon receiving such a command, operational mode switch unit 122 starts up in the sleep mode (S42). For example, operational mode switch unit 122 commands power supply shut-off unit 130 to keep shutting off the power supply to engine unit 141 and processor 142 of image formation unit 140. Therefore, power from main power supply unit 113 is supplied to main controller 120 and I/F unit 150.

In step S39, when the last operational mode is not the sleep mode (No in S39), the processing proceeds to step S43, and power source controller 164 determines whether or not the last operational mode is the standby mode. When the last operational mode is the standby mode (Yes in S43), the processing proceeds to step S44, and when the last operational mode is not the standby mode (No in S43), the processing proceeds to step S33 of FIG. 5. When determination of No is made in step S43, this indicates that no operational mode information is stored in operational mode storage unit 163, and thus power source controller 164 causes operational mode storage unit 163 to store operational mode information indicating the off mode, and the processing proceeds to step S33.

In step S44, power source controller 164 starts supplying power from main power supply unit 113. For example, power source controller 164 commands power source shut-off unit 112 to supply power, and according to such a command, power source shut-off unit 112 sets the power supply from AC power source 190 to be ON. Consequently, power is supplied from AC power source 190 to main power supply unit 113, and main power supply unit 113 supplies power to main controller 120 and I/F unit 150.

Next, power source controller 164 commands operational mode switch unit 122 to start up in the standby mode (S45). Upon receiving such a command, operational mode switch unit 122 starts up in the standby mode (S46). For example, operational mode switch unit 122 commands power supply shut-off unit 130 to supply power to engine unit 141 and processor 142 of image formation unit 140. Operational mode switch unit 122 then commands image formation controller 121 to perform an initial processing for image formation unit 140. Upon receiving such a command, image formation controller 121 performs the initial processing for image formation unit 140 after the start of the power supply to image formation unit 140.

The embodiment described above adopts a configuration in which power source management unit 160 is provided which is operable with lower power consumption than in main controller 120, and the operational mode information indicating the operational mode of image formation apparatus 100 is stored. Because of this, even when the power supply from AC power source 190 is set to be ON or OFF at the time of recovery from a failure, such as a power failure, the state of image formation apparatus 100 before the power failure may be resumed without wastefully consuming power.

In the embodiment described above, a description is given by using three modes: the standby mode, the sleep mode, and the off mode as the operational modes. However, a configuration may be adopted which includes more than three operational modes.

The embodiment described above has a configuration in which pressing power source switch unit 161 causes a switch to the off mode. However, the invention is not limited to such an example. For example, an auto-off function may be provided in which when image formation controller 121 determines that a predetermined operation has not been performed for a predetermined time since the operational mode is set in the sleep mode, operational mode switch unit 122 switches the operational mode from the sleep mode to the off mode. In this case, the off mode due to an operation of power source switch unit 161 and the off mode due to auto-off may be distinguished as different operational modes, and operations at the time of the recovery of the power supply from AC power source 190 may be switchable. For example, power source controller 164 stores operational mode information in operational mode storage unit 163. The operational mode information is that in which the off mode switched by an operation of power source switch unit 161 and the off mode (auto-off) switched by a determination of operational mode switch unit 122 are distinguished. When the last operational mode is the off mode switched by an operation of power source switch unit 161 at the time of the input of power from AC power source 190, power source controller 164 starts up in the off mode. On the other hand, when the last operational mode is the off mode (auto-off) switched by a determination of operational mode switch unit 122, power source controller 164 commands power source shut-off unit 112 to supply power from main power supply unit 113, and commands operational mode switch unit 122 to start up in the standby mode. Upon receiving such a command, operational mode switch unit 122 starts up in the standby mode.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image formation apparatus that operates in a first operational mode and a second operational mode which consumes less power than the first operational mode, the image formation apparatus comprising:
an interface unit configured to receive image formation data;
an image formation unit configured to form an image based on the image formation data received by the interface unit;
a main controller configured to control the interface unit and the image formation unit;
a power supply unit configured to supply power from an external power source into the image formation apparatus; and
a power source management unit configured to control the power supply unit,
wherein when a power supply from the external power source is stopped in the second operational mode and then the power supply from the external power source is resumed, the power supply unit supplies no power to the interface unit and the main controller, but supplies power to the power source management unit, and
when the power supply from the external power source is stopped in the first operational mode and then the power supply from the external power source is resumed, the power supply unit supplies power to the power source management unit, the interface unit, and the main controller.

2. The image formation apparatus according to claim 1,
wherein the second operational mode is an off mode in which power is not supplied from the power supply unit to the image formation unit, the main controller, and the interface unit.

3. The image formation apparatus according to claim 1,
wherein the first operational mode includes:
a sleep mode in which power is not supplied from the power supply unit to the image formation unit, but power is supplied from the power supply unit to the interface unit, the main controller, and the power source management unit, and
a standby mode in which power is supplied from the power supply unit to the image formation unit, the interface unit, the main controller, and the power source management unit.

4. The image formation apparatus according to claim 3, further comprising
a power supply shut-off unit configured to shut off a power supply from the power supply unit to the image formation unit,
wherein in the sleep mode, the power supply shut-off unit shuts off the power supply from the power supply unit to the image formation unit, and
in the standby mode, the power supply shut-off unit does not shut off the power supply from the power supply unit to the image formation unit.

5. The image formation apparatus according to claim 1,
wherein the power supply unit includes:
a sub power supply unit configured to supply power to the power source management unit,
a main power supply unit configured to supply power to the interface unit, the main controller, and the image formation unit, and
a power source shut-off unit configured to shut off the power supply from the external power source to the main power supply unit, and
in the first operational mode, the power source shut-off unit does not shut off the power supply from the external power source to the main power supply unit, and
in the second operational mode, the power source shut-off unit shuts off the power supply from the external power source to the main power supply unit.

6. The image formation apparatus according to claim 5,
wherein the power source management unit includes:
an operational mode storage unit configured to store operational mode information indicating an operational mode of the image formation apparatus; and
a power source controller configured to control the power source shut-off unit, and
when the power supply from the external power source is resumed and the operational mode information stored in the operational mode storage unit indicates the first operational mode, the power source controller does not allow the power source shut-off unit to shut off the power supply from the external power source to the main power supply unit, and
when the power supply from the external power source is resumed and the operational mode information stored in the operational mode storage unit indicates the second operational mode, the power source controller allows the power source shut-off unit to shut off the power supply from the external power source to the main power supply unit.

7. The image formation apparatus according to claim 6,
wherein the power source management unit further includes a power source switch unit configured to receive an input of an operation,
when the power source switch unit receives an input of an operation in the first operational mode, the power source controller allows the power source shut-off unit to shut off the power supply from the external power source to the main power supply unit, and causes the image formation apparatus to be switched to the second operational mode, and
when the power source switch unit receives an input of an operation in the second operational mode, the power source controller does not allow the power source shut-off unit to shut off power supply from the external power source to the main power supply unit, and causes the image formation apparatus to be switched to the first operational mode.

8. An image formation apparatus that operates in a first operational mode and a second operational mode which consumes less power than the first operational mode, the image formation apparatus comprising:
an interface unit configured to receive image formation data;
an image formation unit configured to form an image based on the image formation data received by the interface unit;
a main controller configured to control the interface unit and the image formation unit;
a power supply unit configured to supply power from an external power source into the image formation apparatus; and
a power source management unit configured to control the power supply unit and receive an input of an operation,
wherein in a state where the image formation apparatus is switched to the second operational mode due to the input of an operation received by the power source management unit, when a power supply from the external power source is stopped and then the power supply from the external power source is resumed, the power supply unit supplies no power to the interface unit and the main controller, but supplies power to the power source management unit,
in a state where the image formation apparatus is switched to the second operational mode due to a non-operation of the image formation apparatus for a predetermined time, when the power supply from the external power source is stopped and then the power supply from the external power source is resumed, the power supply unit supplies power to the power source management unit, the interface unit, and the main controller, and
when the power supply from the external power source is stopped in the first operational mode and then the power supply from the external power source is resumed, the power supply unit supplies power to the power source management unit, the interface unit, and the main controller.
